(19) United States
(12) Patent Application Publication
(10) Pub. No.: US 2011/0175950 A1
(43) Pub. Date: Jul. 21, 2011

(54) ILLUMINATING APPARATUS AND LIQUID CRYSTAL DISPLAY APPARATUS PROVIDED WITH THE SAME

(75) Inventors: Hiroyuki Nabesawa, Osaka-shi (JP); Akira Tomiyoshi, Osaka-shi (JP)

(73) Assignee: SHARP KABUSHIKI KAISHA, Osaka-shi, Osaka (JP)

(21) Appl. No.: 13/120,718

(22) PCT Filed: Jun. 15, 2009
(86) PCT No.: PCT/JP2009/060843

§ 371 Date: Mar. 24, 2011

(30) Foreign Application Priority Data
Oct. 6, 2008 (JP) 2008-259195

(51) Int. Cl. G09G 3/36; H05B 37/02; G09G 5/10

(52) U.S. Cl. 345/690; 315/294; 345/102

(57) ABSTRACT

Provided is an illuminating apparatus wherein luminosity deterioration of illuminating light can be suppressed. An illuminating apparatus (10) is provided with a main controller (11), which specifies an LED having the most significant deterioration from among a red LED (3a), a green LED (3b) and a blue LED (3c) for each of a plurality of light emitting elements (3) in a color shade correcting operation, and classifies the light emitting elements (3) into a first group to be subjected to color shade correction and a second group not to be subjected to color shade correction, based on the deterioration ratio of the LED having the most significant deterioration.

### TECHNICAL FIELD

The present invention relates to an illumination device and a liquid crystal display device including the illumination device.

### BACKGROUND ART

Conventionally, there is known an illumination device that uses, as a light source, a red light emitting diode (red LED) which emits red light, a green light emitting diode (green LED) which emits green light and a blue light emitting diode (blue LED) which emits blue light; the illumination device is utilized as a backlight unit that illuminates the liquid crystal display panel of a liquid crystal display device. In this type of conventional illumination device, three types of LED light (red light, green light and blue light) are mixed to produce white light, and the white light is used as the illumination light (see, for example, patent document 1).

Incidentally, in the conventional illumination device described above, in order to satisfactorily produce color shade of white light that is the illumination light, it is necessary to appropriately set the brightness ratio of the three types of LED light. Hence, conventionally, currents supplied to the red LED, the green LED and the blue LED are set such that an appropriate brightness ratio of the three types of LED light is acquired.

However, as shown in FIG. 6, the degradation rates of the red LED, the green LED and the blue LED differ from each other, and the difference between the degradation rates gradually increases as they are used longer. In other words, any one of the red LED, the green LED and the blue LED may be degraded more significantly than the other LEDs. The degradation rates shown in FIG. 6 are assumed to be 100% at the time of initial use. “R”, “G” and “B” shown in FIG. 6 represent the degradation rates of the red LED, the green LED and the blue LED, respectively.

When the difference between the degradation rates is increased, if currents are supplied to the LEDs under the same conditions as the initial use, the brightness ratio of the three types of LED light significantly differs from the appropriate initial value. This disadvantageously results in unsatisfactory color shade of the illumination light. In order to overcome the disadvantage, the conventional illumination device is configured such that it can perform an operation of correcting the color shade of the illumination light.

In the conventional illumination device, when the color shade correction operation is performed, the brightness of light emitted from the red LED, the green LED and the blue LED is measured, and thus the degradation rate of each LED is acquired. Then, after correction values of the red LED, the green LED, and the blue LED are calculated from their degradation rates, currents supplied to the LEDs are corrected based on the correction values, with the result that the brightness ratio of the three types of LED light is returned to the initial state. In this way, the color shade of the illumination light acquired by mixing the three types of LED light is corrected such that it is returned to the initial state.

### PRIOR ART DOCUMENT

### Patent Document

Patent Document 1: JP-A-2004-93761

### DISCLOSURE OF THE INVENTION

### Problems to be Solved by the Invention

However, with the conventional illumination device described above, there is a case in which accurate measurement of the brightness of the three types of LED light is hindered by external light (light other than the LED light) entering the device when the color shade correction operation is performed. That is, in such a case, the correction values, which are calculated from the brightness (the degradation rates) of light emitted from the red LED, the green LED and the blue LED, are not accurate, and this makes it disadvantageously difficult to accurately correct the color shade of the illumination light.

The present invention is designed to overcome the foregoing problem, and an object of the present invention is to provide an illumination device capable of accurately correcting the color shade of illumination light, and a liquid crystal display device including the same.

### Means for Solving the Problem

To achieve the above object, according to a first aspect of the present invention, an illumination device that mixes red light, green light and blue light to generate illumination light and that uses the illumination light to illuminate a member to be illuminated is provided with: a plurality of light emitting elements, each including a red light emitting diode that emits red light, a green light emitting diode that emits green light and a blue light emitting diode that emits blue light; a light receiving element that receives light emitted from each of the red light emitting diode, the green light emitting diode and the blue light emitting diode and that outputs an output value corresponding to a brightness of the received light; and a control portion that performs a color shade correction operation of correcting a color shade of the illumination light by determining degradation rates of the red light emitting diode, the green light emitting diode and the blue light emitting diode from the output value outputted from the light receiving element and adjusting, based on the degradation rates, currents supplied to the red light emitting diode, the green light emitting diode and the blue light emitting diode. Here, the control portion is configured to perform control such that, when the color shade correction operation is performed, the control portion determines whether or not a brightness of external light that is received by the light receiving element affects the color shade correction operation, the control portion stopping the color shade correction operation in a case in which it is determined that the brightness of the external light affects the color shade correction operation, and the control portion starting the color shade correction operation in a case in which it is determined that the brightness of the external light does not affect the color shade correction operation.

As described above, the control portion is configured to perform control such that, when the color shade correction operation is performed, whether or not a brightness of external light that is received by the light receiving element affects the color shade correction operation is determined, and the color shade correction operation is stopped in the case in which it is determined that the brightness of the external light affects the color shade correction operation, while the color shade correction operation is started in the case in which it is determined that the brightness of the external light does not affect the color shade correction operation. The provision of the control portion makes it possible to control such that the color shade correction operation is not performed if external light having a brightness that affects the color shade correction operation enters the device. As a result, the color shade correction operation is performed only when no external light having a brightness that affects the color shade correction operation enters the device. With this configuration, the output value outputted from the light receiving element (a value corresponding to the brightness of light emitted from each of the red light emitting diode, the green light emitting diode, and the blue light emitting diode), based on which the color shade correction operation is performed, is not largely affected by the external light, and this results in acquisition of accurate degradation rates of the red, green, and blue light emitting diodes. Thus, by performing the color shade correction operation based on the degradation rates, the accuracy of the color shade correction of the illumination light can be improved.

Incidentally, when the color shade correction operation is performed, if it is determined that the brightness of the external light affects the color shade correction operation, an error message may be outputted advising the user to take some measure such as darkening the environment, to thereby achieve accurate correction of the color shade of the illumination light.

Preferably, in the illumination device of the first aspect, when the color shade correction operation is performed, control is performed such that all of the light emitting elements are in an OFF state, and the brightness of the external light is acquired from an output value outputted from the light receiving element when all of the light emitting elements are in the OFF state. With this configuration, since the output value outputted from the light receiving element outputs when all of the light emitting elements are in the OFF state corresponds to the brightness of the external light, it is easy to acquire the brightness of the external light when the color shade correction operation is performed.

Preferably, in this case, whether to stop or start the color shade correction operation is determined based on the output value outputted from the light receiving element when all of the light emitting elements are in the OFF state.

Preferably, in the above case, when the color shade correction operation is performed, the color shade correction operation is stopped in a case in which the output value outputted from the light receiving element when all of the light emitting elements are in the OFF state is a predetermined value or larger, and the color shade correction operation is started in a case in which the output value outputted from the light receiving element when all of the light emitting elements are in the OFF state is smaller than the predetermined value.

According to a second aspect of the present invention, a liquid crystal display device includes an illumination device according to the first aspect of the present invention and a liquid crystal display panel that is illuminated by the illumination device. With this configuration, it is possible to improve the accuracy of the color shade correction of illumination light for illuminating the liquid crystal display panel.

### Advantages of the Invention

As described above, according to the present invention, it is possible to easily acquire an illumination device that can correct the color shade of the illumination light accurately, and a liquid crystal display device including the illumination device.

### BRIEF DESCRIPTION OF DRAWINGS

FIG. 1 An exploded perspective view of an illumination device according to an embodiment of the present invention;

FIG. 2 An enlarged plan view of a light emitting portion of the illumination device according to the embodiment shown in FIG. 1;

FIG. 3 A cross-sectional view taken along line 100-100 of FIG. 2;

FIG. 4 A block diagram of a control system of the illumination device according to the embodiment shown in FIG. 1;

FIG. 5 A flowchart illustrating an operation of correcting color shade operated by the illumination device according to the embodiment of the present invention; and

FIG. 6 A graph illustrating the degradation rates of LEDs.

### BEST MODE FOR CARRYING OUT THE INVENTION

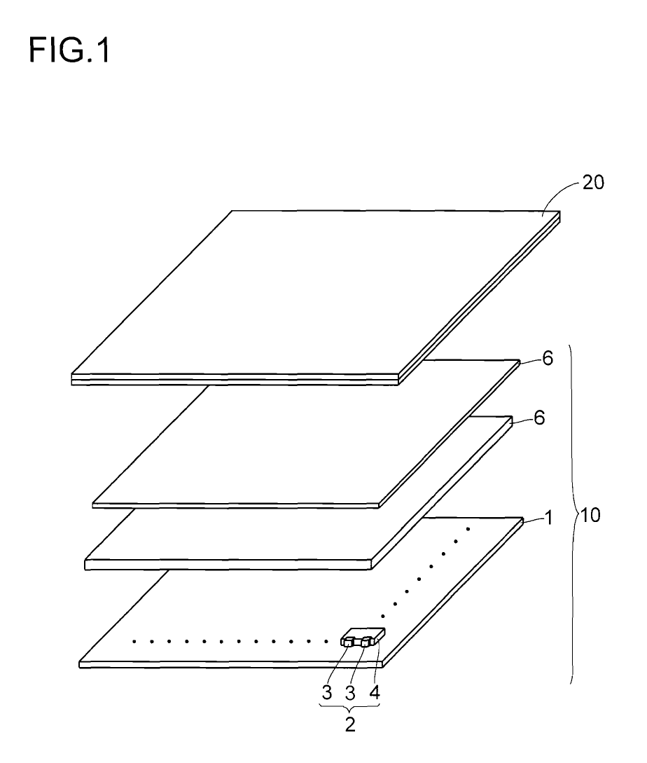

The overall configuration of an illumination device 10 of the present embodiment will be described below with reference to FIGS. 1 to 4.

As shown in FIG. 1, the illumination device 10 of the present embodiment is used as a backlight unit that illuminates a liquid crystal display panel (a member to be illuminated) 20 of a liquid crystal display device; the illumination device 10 is configured to emit planar white light as illumination light. When the illumination device 10 of the present embodiment is used as a backlight, the illumination device 10 is arranged on the back surface side of the liquid crystal display panel 20 opposite the display surface side thereof.

The illumination device 10 of the present embodiment employs a tandem method, and has a plurality of light emitting portions (composed of light emitting elements 3 and light guide plates 4) 2 that are arranged in a matrix on a substrate 1. Each of the light emitting portions 2 generates white light as illumination light, and emits the generated white light to the liquid crystal display panel 20.

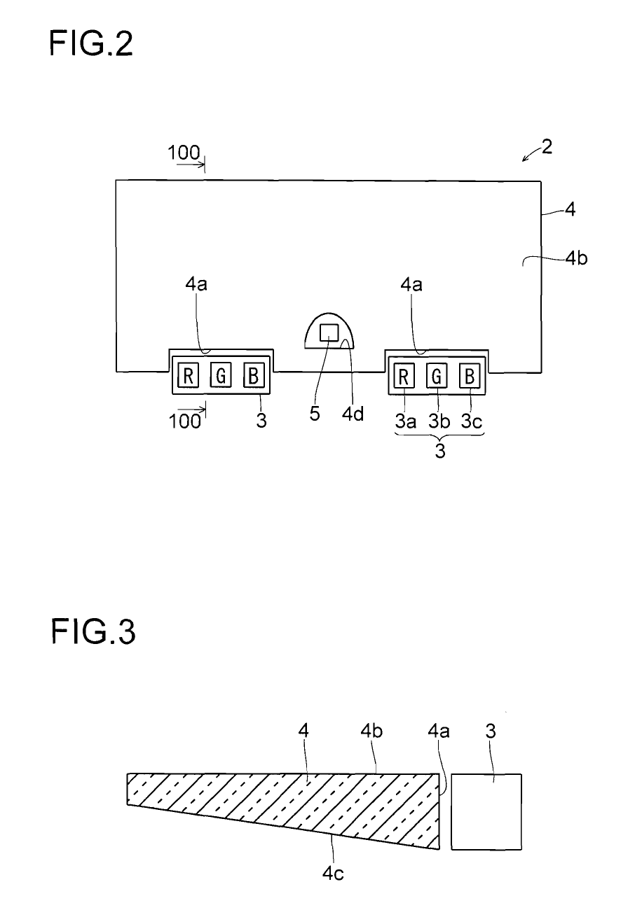

As shown in FIG. 2, each of the light emitting portions 2 is composed of the light emitting elements 3 and the light guide plate 4. Two light emitting elements 3, which are components of the light emitting portion 2, are provided in each of the light emitting portions 2. The light emitting element 3 includes a red LED (red light emitting diode) 3a that emits red light, a green LED (green light emitting diode) 3b that emits green light and a blue LED (blue light emitting diode) 3c that emits blue light; the light emitting element 3 has a structure in which they are fitted to a package. The white light is acquired by mixing the three types of LED light (red light, green light and blue light) emitted from the red LED 3a, the green LED 3b and the blue LED 3c. Specifically, currents supplied to the red LED 3a, the green LED 3b and the blue LED 3c are individually adjusted, and thus the brightness ratio of the three types of LED light is adjusted to an appropriate value, with the result that satisfactory white light is acquired when the three types of LED light are mixed. The red LED 3a, the green LED 3b and the blue LED 3c can independently emit light when an operation of correcting color shade, which will be described later, is performed.

As shown in FIGS. 2 and 3, the light guide plate 4, which is a component of the light emitting portion 2, is used to guide light emitted from the light emitting elements 3 to the liquid crystal display panel 20; one light guide plate 4 is provided in each of the light emitting portions 2. In other words, light emitted from two light emitting elements 3 is guided by one light guide plate 4.

The light guide plate 4 has at least a light receiving surface 4a that is arranged to face the light emission surface of the light emitting element 3, a light emitting surface 4b that is formed with a surface (surface facing the liquid crystal display panel 20) perpendicular to the light receiving surface 4a and a back surface 4c that is a surface opposite the light emitting surface 4b. The light guide plate 4 is formed such that, as the light guide plate 4 extends from the light receiving surface 4a, the thickness of the plate is gradually reduced, that the back surface 4c is inclined and that the light guide plate 4 is wedge-shaped. In a predetermined portion of the light guide plate 4, a through hole 4d is formed that penetrates the light guide plate 4 in the thickness direction of the plate.

As shown in FIG. 2, in each of the light emitting portions 2, there is provided a photodiode (light receiving element) 5 that is inserted into the through hole 4d of the light guide plate 4. The photodiode 5 receives the three types of LED light guided in the light guide plate 4, and outputs a value corresponding to the brightness of the received LED light. The output value of the photodiode 5 is used when the operation of correcting color shade, which will be described later, is performed.

As shown in FIG. 1, optical sheets 6 that light from the light emitting portions 2 enters are provided above the light emitting portions 2 (on the side of the liquid crystal display panel 20). The light from the light emitting portions 2 is diffused and collected by the optical sheets 6.

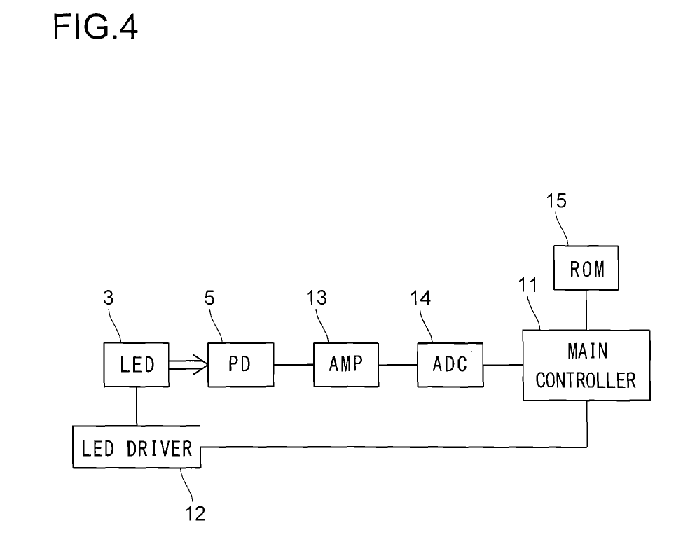

Incidentally, the red LED 3a, the green LED 3b and the blue LED 3c, which generate white light as the illumination light, are gradually degraded as they are used longer, and their degradation rates differ from each other. When any one of the red LED 3a, the green LED 3b and the blue LED 3c is degraded more significantly than the other LEDs, the brightness ratio of the three types of LED light differs from an appropriate initial value, with the result that the illumination light does not serve as satisfactory white light. Hence, in the illumination device 10 of the present embodiment, there is provided a control system (see FIG. 4) that can return the color shade of the illumination light to the initial state when unsatisfactory color shade of the illumination light is produced.

As shown in FIG. 4, in the control system provided in the illumination device 10 of the present embodiment, an LED driver 12 is connected to a main controller 11, and currents supplied from the LED driver 12 to the light emitting elements (LEDs) 3 are controlled by the main controller 11. The main controller 11 is an example of a “control portion” of the present invention.

The control system is provided with an amplification circuit (AMP) 13 that has the function of amplifying an output value of the photodiode (PD) 5 to convert it from a current signal to a voltage signal, an A-D converter (ADC) 14 that has the function of converting the signal from the amplification circuit (AMP) 13 from analog to digital and the like. The photodiode 5 is connected to the main controller 11 through the amplification circuit 13 and the A-D converter 14. Specifically, the output value of the photodiode 5 is input to the main controller 11 through the amplification circuit 13 and the A-D converter 14. A memory (ROM) 15 is connected to the main controller 11; the initial values of the brightness of the three types of LED light are stored in the memory.

The color shade correction operation of correcting the color shade of the illumination light is controlled by the main controller 11. Specifically, when the mode is switched from a normal mode to a correction mode, the main controller 11 determines the degradation rates of the red LED 3a, the green LED 3b and the blue LED 3c from the output value of the photodiode 5, and currents supplied to the LEDs are adjusted based on the degradation rates. The degradation rates of the red LED 3a, the green LED 3b and the blue LED 3c are determined by comparison with the initial values stored in the memory 15. The control is performed in this way, and thus it is possible to return the brightness ratio of the three types of LED light to the initial state. This results in satisfactory color shade of the illumination light.

Here, in the illumination device of the present embodiment, when the color shade correction operation is performed, it is determined whether or not the brightness of external light (light other than the LED light) received by the photodiode 5 affects the color shade correction operation, and in a case in which it is determined that the brightness of the external light affects the color shade correction operation, the color shade correction operation is stopped, while, in a case in which it is determined that the brightness of the external light does not affect the color shade correction operation, the color shade correction operation is started. The above-described color shade correction operation is performed by the main controller 11, and in a case in which the output value of the photodiode 5 when all of the light emitting elements 3 are in the OFF state is a predetermined value or larger, the color shade correction operation is stopped by the main controller 11. On the other hand, in a case in which the output value of the photodiode 5 when all of the light emitting elements 3 are in the OFF state is smaller than the predetermined value, the color shade correction operation is started by the main controller 11. Incidentally, the predetermined value, based on which whether or not the brightness of external light affects the color shade correction operation is determined, is smaller than a value corresponding to the brightness of the external light that affects the color shade correction operation.

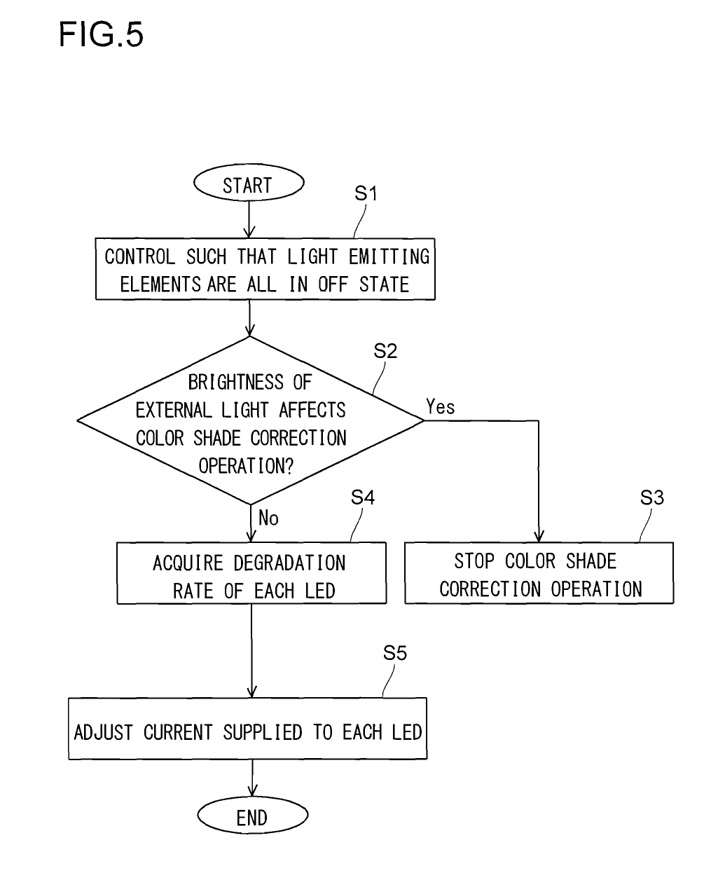

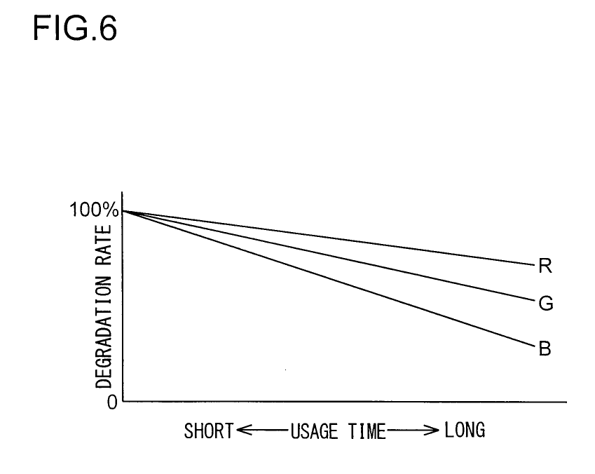

The color shade correction operation of the illumination device 10 of the present embodiment will be described below with reference to FIG. 5.

First, in step S1, supplies of current to all of the light emitting elements 3 are stopped such that all of the light emitting elements 3 are in an OFF state (state in which the photodiode 5 receives no LED light). Thereby is acquired an output value that the photodiode 5 outputs when all of the light emitting elements 3 are in the OFF state.

If external light enters the device at this time, the photodiode 5 receives the external light, and thus the photodiode 5 does not output “0” as its output value; that is, the photodiode 5 outputs a value corresponding to the brightness of the external light that enters the device. Thus, in step S1, the external light that enters the device is detected by the photodiode 5. The output value of the photodiode 5 is fed to the main controller 11 via the amplification circuit 13 and the A/D converter 14.

Then, in step S2, based on the output value (value corresponding to the brightness of the external light that has entered the device) of the photodiode 5 outputted when all of the light emitting elements 3 are in the OFF state, it is determined whether or not the brightness of the external light affects the color shade correction operation. This determination is made by the main controller 11, such that, in a case in which the output value of the photodiode 5 when all of the light emitting elements 3 are in the OFF state the predetermined value or larger, the main controller 11 determines that the brightness of the external light that has entered the device affects the color shade correction operation, and on the other hand, in a case in which the output value of the photodiode 5 when all of the light emitting elements 3 are in the OFF state is smaller than the predetermined value, the main controller 11 determines that the brightness of the external light that has entered the device does not affect the color shade correction operation.

In the case in which it is determined that the brightness of the external light affects the color shade correction operation (that is, in the case in which the output value of the photodiode 5 when all of the light emitting elements 3 are in the OFF state is the predetermined value or larger), the process proceeds to step S3, where the color shade correction operation is stopped. Incidentally, in the case in which the color shade correction operation is stopped, an error message, for example, may be outputted advising the user to deal with the situation by taking some measure such as darkening the environment.

On the other hand, in the case in which it is determined that the brightness of the external light does not affect the color shade correction operation (that is, in the case in which the output value of the photodiode 5 when all of the light emitting elements 3 are in the OFF state is smaller than the predetermined value), the process proceeds to step S4, where the color shade correction operation is continued.

Next, in step S4, the brightness of the red LED 3a, the green LED 3b and the blue LED 3c is individually measured, and thus the degradation rate of each LED is determined. Specifically, the red LED 3a, the green LED 3b and the blue LED 3c first emit light sequentially on a one-by-one basis. Here, light emitted from the red LED 3a, the green LED 3b and the blue LED 3c is received by the photodiode 5, and a value corresponding to the brightness of the received LED light is the output value of the photodiode 5.

The output value of the photodiode 5 is output to the main controller 11 through the amplification circuit 13 and the A-D converter 14. Then, the main controller 11 compares the output value (value corresponding to the brightness of LED light at the time of correction) of the photodiode 5 with the initial value (value corresponding to the brightness of LED light at the time of initial use) stored in the memory 15, and the degradation rates of the red LED 3a, the green LED 3b and the blue LED 3c are determined.

Then, in step S5, the currents supplied to the LEDs are adjusted based on the degradation rates of the red LED 3a, the green LED 3b and the blue LED 3c. The adjustment of the supplied currents is controlled by the main controller 11; the currents are supplied by the LED driver 12 to the red LED 3a, the green LED 3b and the blue LED 3c.

When the supplied currents are adjusted, an LED that is degraded most significantly among the red LED 3a, the green LED 3b, and the blue LED 3c is identified first. Then, control is performed such that a current supplied to the LED that is degraded most significantly is fixed, and that currents supplied to the other LEDs are reduced. In other words, while the brightness of the LED that is degraded most significantly is fixed, the brightness of the other LEDs is adjusted. Thus, the brightness ratio of the three types of LED light is returned to the initial state. Consequently, the color shade of the illumination light acquired by mixing the three types of LED light is adjusted to the initial state. The adjustment of the supplied currents is performed individually on all of the plurality of light emitting elements 3.

In this embodiment, as described above, when the color shade correction operation is performed, the main controller 11 determines whether or not the brightness of the external light that is received by the photodiode 5 affects the color shade correction operation, the main controller 11 stopping the color shade correction operation in a case in which it is determined that the brightness of the external light affects the color shade correction operation, while, on the other hand, the main controller 11 starting the color shade correction operation in a case in which it is determined that the brightness of the external light does not affect the color shade correction operation. The provision of the main controller 11 makes it possible to perform control such that, if external light having a brightness that affects the color shade correction operation has entered the device, the color shade correction operation is not performed with the external light entering the device. That is, the color shade correction operation is performed only when no external light having a brightness that affects the color shade correction operation has entered the device. In this case, the output value of the photodiode 5 (value corresponding to the brightness of light emitted from each of the red LED 3a, the green LED 3b, and the blue LED 3c), based on which the color shade correction operation is performed, is not largely affected by the external light, and as a result, accurate degradation rates of the red LED 3a, the green LED 3b, and the blue LED 3c can be acquired. Thus, by performing the color shade correction operation based on the degradation rates acquired in this way, the color shade of the illumination light can be corrected with improved accuracy.

Furthermore, as described above, according to the present embodiment, when the color shade correction operation is performed, control is performed such that all of the light emitting elements 3 are in the OFF state, and thus the output value of the photodiode 5 corresponds to the brightness of the external light; consequently, brightness of external light that enters the device when the color shade correction operation is performed can be acquired with ease.

The embodiments disclosed herein are to be considered in all respects as illustrative and not restrictive. The scope of the present invention is set out in the appended claims and not in the description of the embodiments hereinabove, and includes any variations and modifications within the sense and scope equivalent to those of the claims.

For example, although the above embodiment deals with the case where the present invention is applied to the illumination device using the tandem method, the present invention is not limited to this configuration. The present invention may be applied to illumination devices that do not use the tandem method.

Although the above embodiment deals with the case where one light receiving element is provided for two light emitting elements, the present invention is not limited to this configuration. One light receiving element may be provided for three or more light emitting elements. Alternatively, one light receiving element may be provided for one light emitting element.

### LIST OF REFERENCE SYMBOLS

3 light emitting element
3a red LED (red light emitting diode)
3b green LED (green light emitting diode)
3c blue LED (blue light emitting diode)
5 photodiode (light receiving element)
10 illumination device
11 main controller (control portion)
20 liquid crystal display panel (member to be illuminated)

1. An illumination device that mixes red light, green light and blue light to generate illumination light and that uses the illumination light to illuminate a member to be illuminated, the illumination device comprising:
a plurality of light emitting elements, each including a red light emitting diode that emits red light, a green light emitting diode that emits green light and a blue light emitting diode that emits blue light;
a light receiving element that receives light emitted from each of the red light emitting diode, the green light emitting diode and the blue light emitting diode and that outputs an output value corresponding to a brightness of the received light; and
a control portion that performs a color shade correction operation of correcting a color shade of the illumination light by determining degradation rates of the red light emitting diode, the green light emitting diode and the blue light emitting diode from the output value outputted from the light receiving element and adjusting, based on the degradation rates, currents supplied to the red light emitting diode, the green light emitting diode and the blue light emitting diode,
wherein,
the control portion is configured to perform control such that, when the color shade correction operation is performed, the control portion determines whether or not a brightness of external light that is received by the light receiving element affects the color shade correction operation, the control portion stopping the color shade correction operation in a case in which it is determined that the brightness of the external light affects the color shade correction operation, and the control portion starting the color shade correction operation in a case in which it is determined that the brightness of the external light does not affect the color shade correction operation.

2. The illumination device of claim 1,
wherein, when the color shade correction operation is performed,
control is performed such that all of the light emitting elements are in an OFF state, and the brightness of the external light is acquired from an output value outputted from the light receiving element when all of the light emitting elements are in the OFF state.

3. The illumination device of claim 2,
wherein
whether to stop or start the color shade correction operation is determined based on the output value outputted from the light receiving element when all of the light emitting elements are in the OFF state.

4. The illumination device of claim 3,
wherein,
when the color shade correction operation is performed, the color shade correction operation is stopped in a case in which the output value outputted from the light receiving element when all of the light emitting elements are in the OFF state is a predetermined value or larger, and the color shade correction operation is started in a case in which the output value outputted from the light receiving element when all of the light emitting elements are in the OFF state is smaller than the predetermined value.

5. A liquid crystal display device comprising:
the illumination device of claim 1; and
a liquid crystal display panel illuminated by the illumination device.

6. A liquid crystal display device comprising:
the illumination device of claim 2; and
a liquid crystal display panel illuminated by the illumination device.

7. A liquid crystal display device comprising:
the illumination device of claim 3; and
a liquid crystal display panel illuminated by the illumination device.

8. A liquid crystal display device comprising:
the illumination device of claim 4; and
a liquid crystal display panel illuminated by the illumination device.
